(19) United States
(12) Patent Application Publication
(10) Pub. No.: US 2013/0008388 A1
(43) Pub. Date: Jan. 10, 2013

(54) Pet Brush and Integrated Spray

(76) Inventors: Katherine Kistler Chancy, Savannah, GA (US); David Calhoun Chancy, JR., Savannah, GA (US)

(21) Appl. No.: 13/544,386

(22) Filed: Jul. 9, 2012

Related U.S. Application Data
(60) Provisional application No. 61/505,232, filed on Jul. 7, 2011.

(51) Int. Cl. A01K 13/00

(52) U.S. Cl. 119/604

(57) ABSTRACT

A pet brush includes a brush unit, and a tonic attachment attachable to and detachable from the brush unit. The tonic attachment is cooperable with the brush unit to define an ergonomic handle-less pet brush.

### CROSS-REFERENCES TO RELATED APPLICATIONS

This application claims the benefit of U.S. Provisional Patent Application Serial No. 61/505,232, filed Jul. 7, 2011, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

Pet owners, particularly of dogs, spend countless hours cleaning, brushing and deodorizing fur. Pets can bring dirt and debris into the house stuck to their fur, which ends up on floors, furniture, and walls. While there are sprays and brushes, the sight of the spray bottle can make dogs run away. They are both scared of the spray bottles, and it is a burden to try to spray freshening spray/neutralizer on an animal's fur as they are running away. Although they do not mind being brushed, the process of chasing dogs down to spray them then keeping them still long enough after being sprayed to brush is not a pleasurable experience at all. Dogs that are uncomfortable with spray deodorizers or bottles may feel as though they are being punished, which of course is undesirable.

### SUMMARY OF THE INVENTION

The pet brush according to the preferred embodiments is a 2-in-1 pet product that will appeal to the busy pet and pet owner on the go. The product is essentially an ergonomic handle-less pet brush with two main parts, and when the two parts of the brush are in place together, the brush can be in the shape of a paw. The main body of the brush will be a unique shaped bottle that will be filled with a proprietary tonic. The bottle will fit into a brush to make the brush whole. The bottle includes a spray trigger that extends through an opening in the brush. As the user is spraying the solution on the animal's fur, they will also be able to brush the animal's fur, as there will be pin wire bristles on the bottom of the brush.

Instead of having two products (the pet spray bottle and the pet brush), the pet brush according to preferred embodiments combines these products into one and makes the process of quickly cleaning pet fur and removing odor much easier and much more pleasurable for the animal. As the tonic is sprayed on the pet's fur, the dog owner can also begin brushing the pet's coat all in one motion. This will save time and will be a much more pleasurable experience for the user and the pet. Preferably, the pet brush may also come with a carrying case that will allow room for the pet brush and also for one additional tonic canister.

In an exemplary embodiment, a pet brush includes a housing, a brush unit coupled with the housing and including brush bristles on one side thereof, a tonic container secured to the housing, and a spray valve cooperable with the tonic container and the brush unit. The housing may include a valve opening through which the spray valve is insertable. In this context, the tonic container may have a shoulder that is correspondingly shaped and cooperable with a lower perimeter of the housing, wherein when assembled, the housing and tonic container define an ergonomic handle-less pet brush. In one embodiment, the ergonomic handle-less pet brush is in the shape of a paw.

The tonic container may include an opening having external threads, wherein the spray valve is threaded onto the external threads of the tonic container. In this context, the spray valve may include a valve tube and a trigger, and the spray valve may also include a weighted end secured at an end of the valve tube, wherein an opening in the valve tube extends through the weighted end.

In another exemplary embodiment, a pet brush includes a brush unit, and a tonic attachment attachable to and detachable from the brush unit, wherein the tonic attachment is cooperable with the brush unit to define an ergonomic handle-less pet brush. A spray valve may be coupled with the tonic attachment, wherein the spray valve is cooperable with the brush unit such that brushing and spraying can be conducted simultaneously. The spray valve may include a trigger that is extendable through an opening in the brush unit, wherein when the tonic attachment is coupled with the brush unit, the pet brush may be held in a user's one hand and the trigger is positioned in a location where the user's index finger will naturally fall.

In yet another exemplary embodiment. a pet brush includes a housing including a container receiving section facing one side thereof. A brush unit is coupled with the housing on an opposite side thereof and includes brush bristles. A tonic container is secured to the housing via engagement with the container receiving section, wherein the tonic container is cooperable with the housing to define an ergonomic handle-less assembly. A spray valve is cooperable with the tonic container and extendable through an opening in the container receiving section.

### BRIEF DESCRIPTION OF THE DRAWINGS

These and other aspects and advantages will be described in detail with reference to the accompanying drawings, in which:

FIG. 1 is a perspective view of the pet brush according to preferred embodiments;

FIG. 2 shows a brush bristle side of the pet brush;

FIG. 3 is a perspective view with the pet brush in a user's hand;

FIG. 4 shows the tonic container being attached to the housing;

FIG. 5 shows parts of the pet brush as assembled; and

FIG. 6 shows details of the tonic container/attachment.

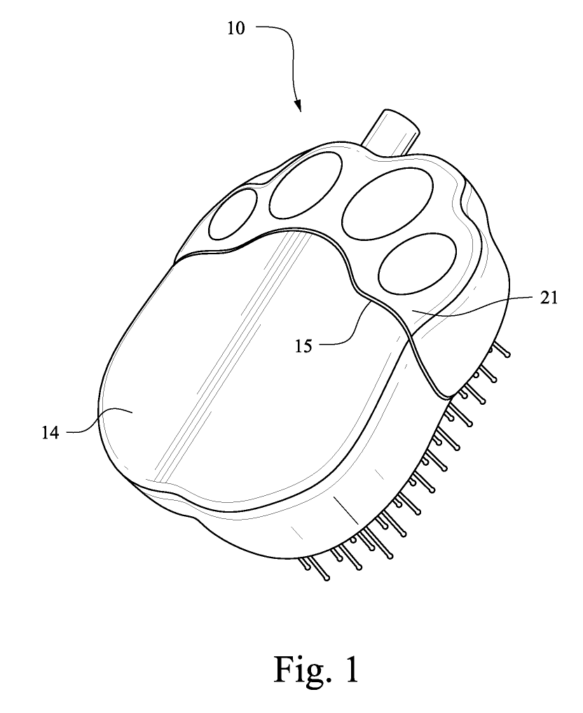

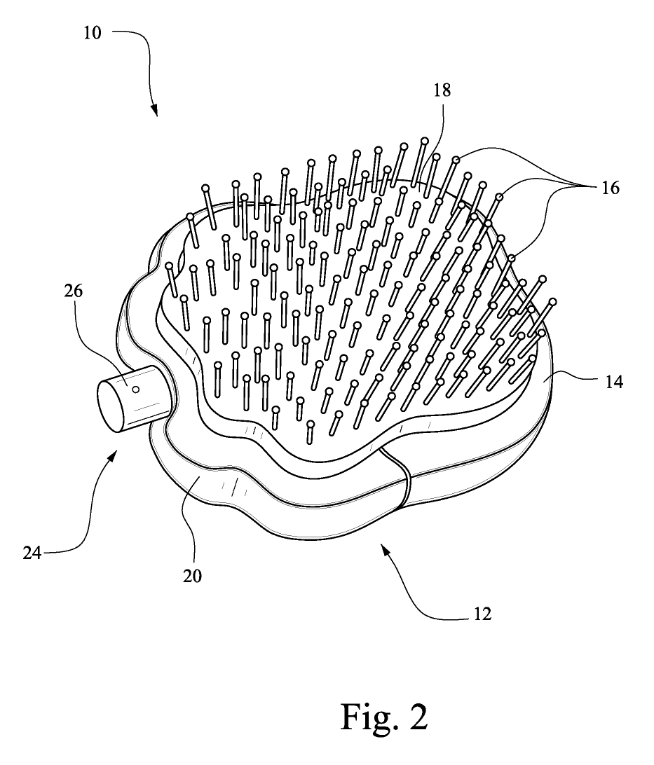

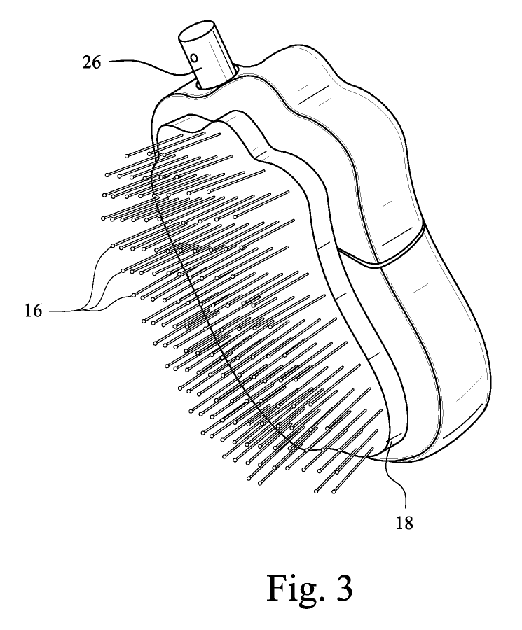

### DETAILED DESCRIPTION OF THE INVENTION

With reference to the drawings, the pet brush 10 according to the invention includes a brush unit 12 and tonic attachment/container 14. As shown, the pet brush 10 when assembled is preferably in the shape of a paw. Of course, other shapes may be contemplated, and the invention is not necessarily meant to be limited to the paw shape shown.

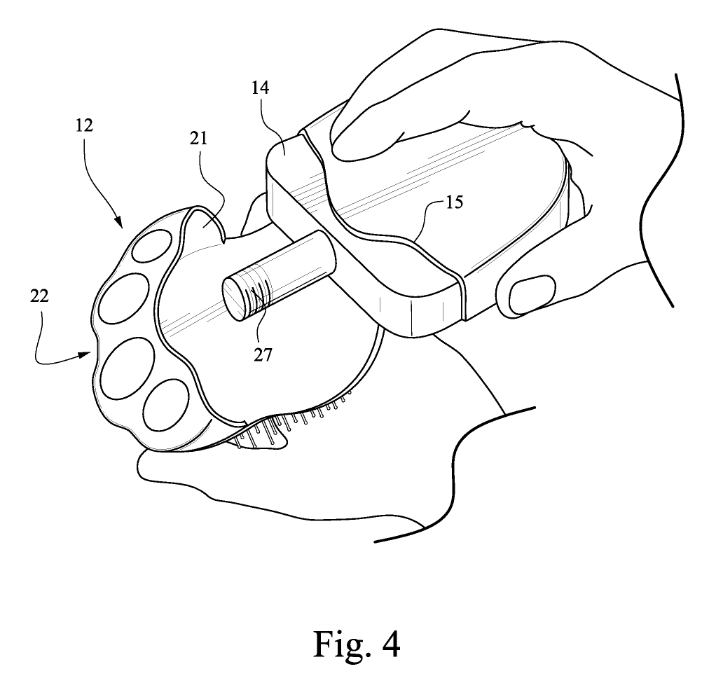

The brush unit 12 includes a plurality of brush bristles 16 secured to a brush base 18 in a known manner. The brush base 18 is affixed to a main housing 20, to which the tonic attachment 14 may be secured. The main housing 20 includes a valve opening 22 for receiving a conventional spray valve 24, which includes a trigger 26, of the tonic attachment 14 (FIG. 4). The main housing 20 includes a tonic attachment receiving section 21 through which the valve opening 22 is formed. The receiving section 21 may include a decorative area as shown that defines part of a paw shape.

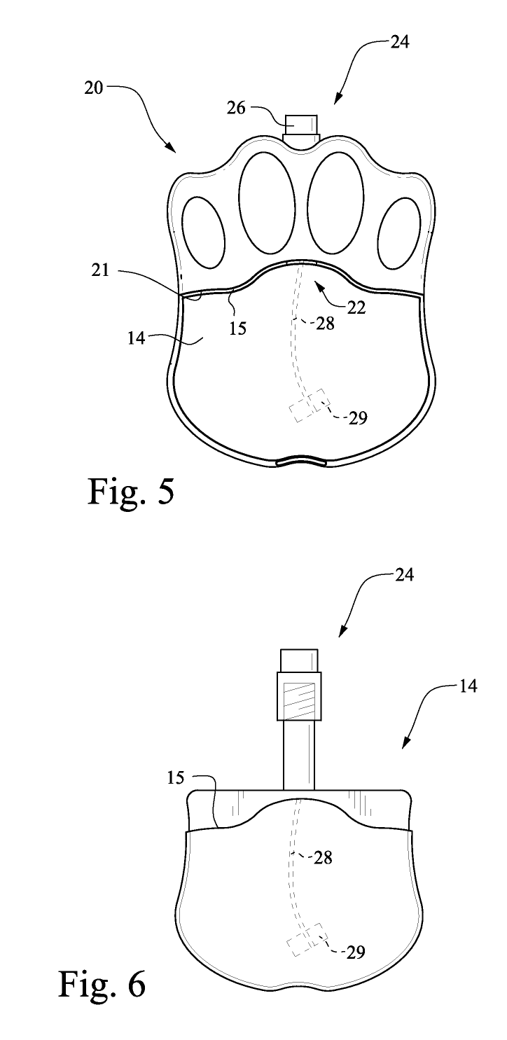

With reference to FIGS. 5 and 6, the tonic attachment 14 comprises a sealed bottle containing the tonic. In a preferred construction, the tonic attachment 14 includes an opening with external threads 27 to which a conventional spray valve 24 including a valve tube 28 is attached. Tonic in the tonic attachment 14 is drawn through the valve tube when the trigger 26 is depressed. The tonic attachment 14 is secured to the main housing 20 by inserting the spray valve 28 through the valve opening 22 in the main housing 20. The housing may include a ridge or the like (as shown in FIG. 5) to hold the tonic attachment 14 in place. The tonic attachment 14 preferably includes a shoulder 15 that may be shaped corresponding to a lower periphery of the receiving section 21 of the main housing 20. With the tonic attachment 14 secured to the main housing 20, the assembly defines an ergonomic handle-less pet brush, forming the preferred paw shape.

The valve tube 28 may be provided with a weighted end 29. The weighted end 29 enables the pet brush 10 to be sprayed in any orientation. For example, in use, with less than about half of the tonic remaining, if the user tilts the pet brush to the side, a conventional valve tube may draw air, stuck in a bottom corner where no tonic is present. With the weighted end 29, however, gravity pulls the weighted end 29 and thereby the valve tube 28 into the same space in which the tonic is displaced by tilting. As such, the end of the valve tube 28 (through the weighted end 29) will remain immersed in the tonic.

Initially, the proprietary tonic may utilize all natural and “green” products. The tonic is solely made up of all natural products. A wire pin bristle brush is preferred, although alternative brush types can be used. Additionally, the entire package may have a variety of different pet tonic options to choose from, and the line may include five different solutions or more. Each of the pet tonic solutions will deodorize and will have a fresh scent, but will not be too overpowering.

Users will be able to purchase additional pet tonic canisters as they can be available in a range of different scents and solutions that will tackle different problems.

### ADVANTAGES

The paw shape of the product will be a major selling point, as it will be cute, as well as comfortable for pets. The paw shape is also more ergonomic for the human hand. With the special “massaging bristles,” the animals will no longer feel as though they are being punished—they will feel like they are being praised. The paw shaped brush will fit in the palm of a user's hand, and as the pet brush is being used, the animal will feel as though it is being petted. With the pet brush according to the described embodiments, pet owners will not have to take pet solution, pet wipes, brushes, etc. with them when they are on the go.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A pet brush comprising:
a housing;
a brush unit coupled with the housing and including brush bristles on one side thereof;
a tonic container secured to the housing; and
a spray valve cooperable with the tonic container and the brush unit.

2. A pet brush according to claim 1, wherein the housing comprises a valve opening through which the spray valve is insertable.

3. A pet brush according to claim 2, wherein the tonic container comprises a shoulder that is correspondingly shaped and cooperable with a lower perimeter of the housing, and wherein when assembled, the housing and tonic container define an ergonomic handle-less pet brush.

4. A pet brush according to claim 3, wherein the ergonomic handle-less pet brush is in the shape of a paw.

5. A pet brush according to claim 1, wherein the tonic container comprises an opening having external threads, and wherein the spray valve is threaded onto the external threads of the tonic container.

6. A pet brush according to claim 5, wherein the spray valve comprises a valve tube and a trigger.

7. A pet brush according to claim 6, wherein the spray valve further comprises a weighted end secured at an end of the valve tube, wherein an opening in the valve tube extends through the weighted end.

8. A pet brush according to claim 6, further comprising means for enabling the spray valve to be operable in any orientation of the pet brush.

9. A pet brush comprising:
a brush unit; and
a tonic attachment attachable to and detachable from the brush unit, wherein the tonic attachment is cooperable with the brush unit to define an ergonomic handle-less pet brush.

10. A pet brush according to claim 9, further comprising a spray valve coupled with the tonic attachment, wherein the spray valve is cooperable with the brush unit such that brushing and spraying can be conducted simultaneously.

11. A pet brush according to claim 10, wherein the spray valve comprises a trigger that is extendable through an opening in the brush unit, and wherein when the tonic attachment is coupled with the brush unit, the pet brush may be held in a user's one hand and the trigger is positioned in a location where the user's index finger will naturally fall.

12. A pet brush according to claim 10, wherein the spray valve comprises a valve tube and a trigger.

13. A pet brush according to claim 12, wherein the spray valve further comprises a weighted end secured at an end of the valve tube, wherein an opening in the valve tube extends through the weighted end.

14. A pet brush according to claim 12, wherein the tonic attachment comprises an opening having external threads, and wherein the spray valve is threaded onto the external threads of the tonic attachment.

15. A pet brush comprising:
a housing including a container receiving section facing one side thereof;
a brush unit coupled with the housing on an opposite side thereof and including brush bristles;
a tonic container secured to the housing via engagement with the container receiving section, wherein the tonic container is cooperable with the housing to define an ergonomic handle-less assembly; and
a spray valve cooperable with the tonic container and extendable through an opening in the container receiving section.

16. A pet brush according to claim 15, wherein the tonic container comprises a shoulder that is correspondingly shaped and cooperable with a lower perimeter of the container receiving section.
